(19) United States
(12) Patent Application Publication
(10) Pub. No.: US 2008/0256192 A1
(43) Pub. Date: Oct. 16, 2008

(54) METHOD AND SYSTEM FOR ASSISTED PRESENCE

(75) Inventors: Deborah L. PINARD, Ottawa (CA); Yi QIN, Nepean (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: FIRSTHAND TECHNOLOGIES INC., Ottawa, ON (CA)

(21) Appl. No.: 11/734,513

(22) Filed: Apr. 12, 2007

(51) Int. Cl. G06F 7/00

(52) U.S. Cl. 709/206

(57) ABSTRACT

A method and system for capturing and managing an indication of availability of a user to make and receive media communications is disclosed. The user availability indication is suitable for use by a user having a plurality of communications devices operable over a variety of media at least some of which are attached to a Session Initiation Protocol (SIP) enabled network. The method and system provide an architecture for managing and publication of user availability information. The method and system provide a user with interfaces for set up, publication and delivery of user availability data that can integrate across different media types. A user can establish role, group, activity and location dependent availability information that is managed and updated automatically according to user defined policies or based on a case-by-case basis as the user interacts with the system of the invention.

### FIELD OF THE INVENTION

The present invention relates generally to a user presence indicator that provides current or real time information relating to user preference and capability to receive communications. More particularly, the present invention provides a system for management of user presence indication information and for providing user communications availability information to facilitate directing and resolving communications sessions with or requests to a user.

### BACKGROUND OF THE INVENTION

In an enterprise having employees and contacts in a variety of jurisdictions over multiple time zones expanding communications options including Public Switched Telephone Network (PSTN) communications as well as Voice over Internet Protocol (VoIP) and other Internet Protocol (IP)-based communication services make arbitrating communication requests to a user and establishing communications sessions with a user complex. To address this need, developers of Private Branch Exchange (PBX) equipment and software have developed IP PBXs to provide the functionality users expect in conventional PBXs, such as conference calling, call forwarding, automatic call distribution, shared message boxes, etc., and to provide new functionality that takes advantage of the multimedia content that can be transmitted over the Internet.

A network protocol called the Session Initiation Protocol (SIP), specified in the RFC 3261 of the Internet Engineering Task Force (IETF) SIP Working Group, is an application-layer control (signaling) protocol for creating, modifying, and terminating sessions with one or more participants, and is widely used as a signaling protocol for Vol P. SIP sessions can be of different media types, including Internet Protocol (IP) telephone calls, instant messaging (IM), multimedia distribution, and multimedia conferences. SIP provides a signaling and call setup protocol for audio, video and text communications over a data network using a variety of protocols, such as Internet Protocol, that can support many of the call processing functions and features present in the PSTN. SIP itself does not define these features. However, SIP permits such features to be built into network elements, such as proxy servers and user agents, and implementing these features permits familiar telephone-like operations, such as dialing a number, causing a phone to ring, and hearing ringback tones or a busy signal.

SIP works in concert with several other protocols and is only involved in the signaling portion of a communication session. SIP acts as a carrier for the Session Description Protocol (SDP), which describes the set up and media content of the session, such as the IP ports to use and the codec being used. SIP clients typically use Transmission Control Protocol (TCP) and User Datagram Protocol (UDP) to connect to SIP servers and other SIP endpoints. SIP is most commonly used to set up and tear down voice and video calls. However, it can be used in any application where session management is a requirement, such as event subscription and notification, and terminal mobility. All communications are done over separate session protocols, typically implementing Real-Time Transport Protocol (RTP).

SIP-enabled telephony networks can also implement many of the more advanced call processing features present in Signaling System 7 (SS7). However, while SS7 is a highly centralized protocol, characterized by complex central network architecture and unintelligent endpoints (conventional telephone handsets), SIP is a peer-to-peer protocol. SIP features are typically implemented in the communicating endpoints (i.e. at the edge of the network) as opposed to traditional SS7 features, which are implemented in the network.

Enterprises, and their employees increasingly rely on mobile communication devices, such as cellular telephones and wireless messaging devices, to carry out day-to-day business communications needs. Currently, there is poor integration between PSTN, cellular and SIP-based services, such as VoIP. Thus, mobile device users generally do not have symmetrical access to the rich IP-enabled features and services, nor do they, typically, have access to the features and services offered by the PBX associated with their enterprise.

A presence indicator, such as that used by Instant Messaging (IM) services to indicate whether an IM user is available to receive a call request is one form of user presence indicator. Other forms of user presence indicators are also known to provide presence indications that are more than just a status for IM. In this context, the following US patent applications may be considered, namely:

U.S. published patent application 20040133638 by Doss, J. Smith et. al. for Calendar-enhanced awareness for instant messaging systems and electronic status boards discloses A method, system, and product for providing calendar-enhanced awareness/presence information for instant messaging systems and electronic status boards. The teachings of Smith et al automate status transitions, enhance and automate status messages, and automate and extend the IM “who can see me” function. Additionally, the disclosure of Smith et. al. teaches a method, system and product that extends awareness to dimensions other than IM status, to include availability in-person, via telephone, via wireless device or wireless messaging device (e.g., pager).

U.S. published patent application 20050182816 by Wanrong Lin et. al. for Automated dissemination of presence and availability schedule discloses a computer system architecture having four interactive elements for disseminating presence and availability information. Lin provides a schedule publication element that acquires information about user schedules and a schedule management element that communicates with the publication element to acquire schedule information and to store integrated schedule information in a storage system. A schedule distribution element acquires schedule information from the schedule management element and selectively disseminates the information to subscribers who have interacted with a schedule subscribing element. Both current and future presence and availability information is thus collected and disseminated in an orderly manner.

U.S. published patent application 20050071426 by Rahul Shah for Method and System for Presence State Assignment Based on Schedule Information in an Instant Messaging System teaches a method and system for presence state assignment based on schedule information in an instant messenger system. In one embodiment, the method of Shah may include storing schedule information corresponding to a given user, where the schedule information is indicative of an activity status of the given user at a given time. The method may further include querying the schedule information, and if a current presence state of an instant messenger does not correspond to the activity status indicated by the schedule information, assigning a different presence state that corresponds to the activity status in response to the querying, where the current presence state and the different presence state each correspond to the given user.

U.S. published patent application 20040249776 by Eric Horvitz et al for Composable Presence and Availability Services discloses a system and methodology to facilitate collaboration and communications between entities such as between parties to a communication, automated applications and components, and/or combinations of these. The systems and methods of Horvitz et al include a service that supports collaboration and communication by learning predictive models that provide forecasts of one or more aspects of a user's presence and availability. Presence forecasts include a user's current location or future locations at different levels of location precision and of the availability to users of different devices or applications. Availability assessments include inferences about the cost of interrupting a user in different ways and a user's current or future access to one or more communication channels that may be supported by one or more devices with appropriate capabilities. The predictive models are constructed via statistical learning methods from data collected by considering user activity and proximity from multiple devices, in addition to analysis of the content of users' calendars, the time of day, and day of week, for example. Beyond ambient data collection, users can provide input via batch input tools or via intermittent probes of their situation and context. Various applications are provided that employ the presence and availability information supplied by the models in order to facilitate collaboration and communications between entities.

U.S. published patent application 20040203659 by Jeffrey Mikan for Apparatus and method for changing instant messaging presence relative to a calendar function discloses an apparatus and method for changing the presence of a user profile active on a communication device on a telecommunications network relative to a calendar function for the communication device.

U.S. published patent application 20040162882 by Gary Mora for Messenger assistant for personal information management discloses a real-time communications device, a real-time communications system of networked distributed such devices and method and program product for operating such devices. The device includes a personal information manager (PIM), an instant messenger and a Messenger Assistant. The device may also include an e-mail client. The Messenger Assistant automatically provides appointment/status information from the PIM to the instant messenger, which passes status to identified buddies. The Messenger Assistant may also monitor local presence and e-mail and update status based on local presence changes and on incoming e-mail.

U.S. published patent application 20040064567 by Smith Doss et al for keeping working hours and calendar entries up-to date discloses techniques for keeping calendars up-to-date, whereby a person's working hours, events, and actual availability are accurately reflected. In response to user-generated input and/or application-generated input, working hours can be updated and calendar events can be added to, deleted from, or changed on the user's calendar. Profiles are preferably used to specify working hours, and a particular user may have one or more profiles available (including a default profile); the user can then easily select from among these profiles to update the working hours for a date/day, or a range of dates/days. Preferences may be associated with the profiles, providing a convenient way of isolating information that applies only to a particular set of working hours.

From the foregoing there are known means for setting a user presence indicator by a manual setting of the user or an automatic setting based on activities or events, for instance: log in, keyboard activity or lack thereof and making a phone call. However, a problem with manual setting is that it relies on input from the user and, for a variety of reasons, is not reliable. A user may just not update their user presence indicator, or may forget to update it, making an indication of user presence based on manual input unreliable. Various implementations of automatic setting of a user presence indicator as described in the foregoing prior art suffer deficiencies as well. For example, an indication of user presence based on automatic setting may result in a setting that the user does not want, or force the user to accept a hard coded setting that the system gives them.

### SUMMARY OF THE INVENTION

The present invention ameliorates or overcomes at least some of the disadvantages of the solutions heretofore proposed by providing an indication of user presence based on automatic setting that conveys a user desired setting, and furthermore, does not force a user to accept a hard coded setting that the user may not be willing or desirous of accepting. The present invention is premised on providing a user presence indicator that is able to convey more information than simply to indicate someone's availability to ‘chat’. In accordance with the invention a user presence indicator is made available to provide others with information such as user location information, media available to the user and what communications facilities the user is able and willing to participate in. Any of the user presence indicator information may vary over time and is able to depend on the particular time that the user presence indicator is queried. In accordance with the invention, a user presence indicator is made available to communicate one or more aspects or factors of a user presence. The time varying factors that are used to determine and communicate a user presence indicator include: Role, Group, Person, Devices, Location and Current Activity.

In one aspect of operation, the invention determines a user's presence by location in the context of a person's current activity and devices available. For example the user may be: on rounds in a hospital with a PDA; at lunch in a restaurant with a PDA; with a patient in an office with a desk phone and laptop; in a meeting in a hospital with a PDA and laptop; at a conference off-premise with a laptop; or on the phone, to illustrate a few examples.

In another aspect of operation, the invention determines a user's user presence indicator by Role and Group and available devices, for example, the user may be a Head Nurse with activity on a PDA media device. To provide a user presence indicator that conveys to others the user's availability, colours can be used. For example: Green (Go Ahead)—I am alone; Yellow (With caution)—I am with people, but can be disturbed, or Red (Emergency Only)—I am with people and cannot be disturbed or I have no media capability.

A user's media capabilities must be determined in each different situation. Preferably, the user has the capability to be able to select their preferred method of communication in particular situations. Trying to determine this automatically can run into problems and counting on the user to remember to set their presence according to their current situation does not work either. With the influx of mobile devices with increasing intelligence capabilities, offering assisted presence functionality to a user ameliorates this problem. Currently automatic presence settings rely on the system guessing the state of the user by certain activities that happen. The present invention permits a user to select and configure triggers that are of most interest to the user in establishing a presence indicator that includes availability aspects or user configured options of that availability. The aspects or options include enabling the user to specify and configure an indication of availability level that should apply to the presence indicator. These include, for example, availability levels such as: red, yellow, green; what media should apply, such as: voice, video, chat, email, fax; and the ability to specify a message or note the user wishes to have associated and what the user preferred media is in that situation. As well as providing the user with functionality to specify these aspects and configure or set these defaults, the user is provided with the capability to configure the system to have it prompt or query them when a trigger occurs to enable the user to reconfigure, reprogram or deny/accept the automatic presence setting for that trigger. Examples of triggers are (1) making or receiving a phone call; (2) keyboard activity or inactivity (either on a PC or mobile device); (3) calendar activity (like a meeting starting or ending). For example, a user could extend a meeting time, and their current presence setting will stay in effect until the meeting is over at which time an end-of-meeting trigger would occur; (4) log out of an enterprise network; (5) use a computer workstation to activate or enter a work-related application, for example, CRM, Salesforce™ etc.; (6) WiFi connectivity or loss of signal event; (7) location aware signal e.g. via Bluetooth or a location sensitive badge.

So for example, when a user leaves a building a loss of WiFi signal connectivity event can be used as a trigger to prompt the user on their mobile device with a simple “Do you want to change your current presence?” and present the user with a list of possible pre-programmed settings to form the basis for accepting a user input, if any. The user can ignore the prompt to accept a default setting, or respond to the prompt with a desired selection or can input another option matching the user's preference. Thus, the user could do nothing and accept a default presence indicator outcome, or the user could respond to the prompt by inputting a selection from one or more preprogrammed presence indicator outcomes or input a user specified presence indicator for instance, “out to Lunch status” with a Yellow availability status indication, a preferred communication type of Chat, and showing voice, chat, video and email as possible media types since the user has a mobile device and is interacting with it to be presented with and make these selections.

In a first aspect, the present invention provides a method of managing a user presence indication by receiving a user presence monitor request including a unique user identifier, a device identifier and then establishing a subscriber process having maintenance access to a subscriber presence record in a subscriber presence data store corresponding to the unique user identifier including a user presence indicator. A monitor interface to a device corresponding to the device identifier is established.

In another aspect, an assisted presence server for managing user presence information has a subscriber process coupled to a user presence data store to store and maintain a user presence data store and a communication device including an interface interoperable with the subscriber process to receive a unique user identifier and store same in said user presence data store. A device monitor interface is in communication with the subscriber process to monitor each communication device to process at least one of: a communication request, produce a user prompt, produce at least one trigger output or effect communication of at least one media type.

The method and system of the present invention permits a user presence indicator to be managed efficiently, and permits a rich feature set user presence indicator to be offered to users. Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 shows an exemplary system architecture according to an embodiment of the present invention;

FIG. 2 is a functional process schematic diagram of an exemplary system software implementation according to an embodiment of the present invention;

FIG. 3 shows a graphical representation of a framework for operation of a method and system for assisted presence with accordance with the principles of the invention.

FIG. 4 illustrates a graphical user interface of an embodiment of the invention.

FIG. 5 illustrates a graphical user interface of another embodiment of the invention.

### DETAILED DESCRIPTION

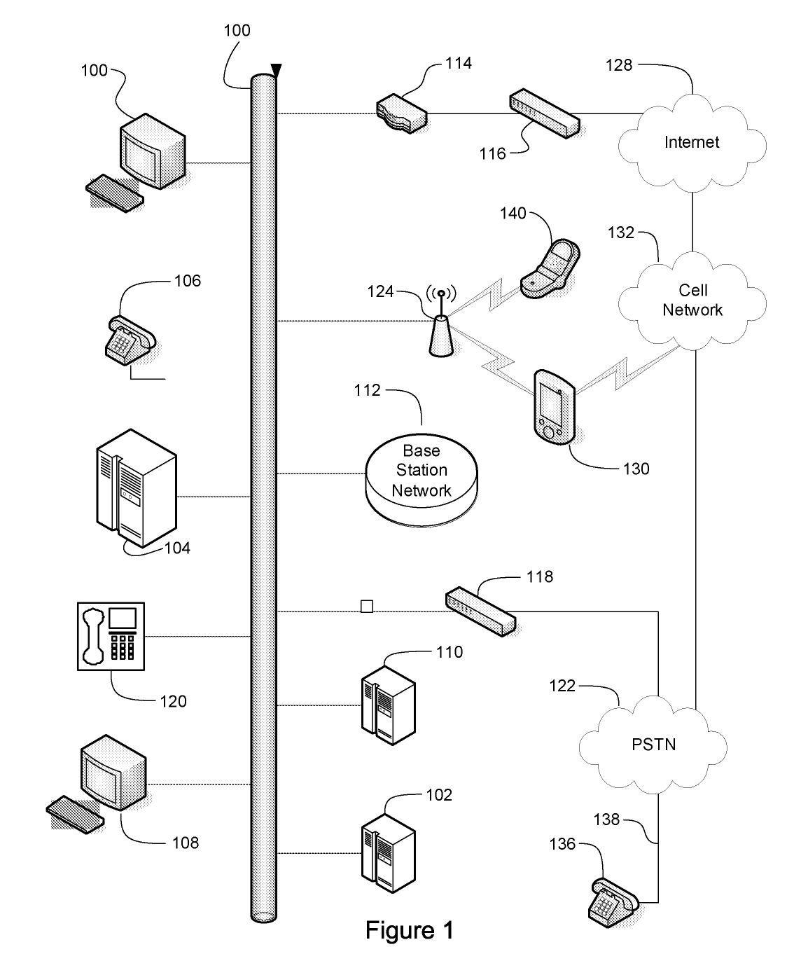

Referring to FIG. 1, a SIP enterprise system architecture according to an embodiment of the present invention, with connections to public networks, is shown. The system architecture is intended to be exemplary only, and the actual system architecture will depend on the services and functionality desired by the enterprise. Typically, the system hardware will be housed in a single building, but distributed architectures are equally contemplated and encompassed by the present invention. The illustrated enterprise hardware comprises at least one Local Area Network (LAN) 100 to which is connected an assisted presence server 102, an Internet Protocol Private Branch Exchange (IP PBX) 104, telephones 106, workstations 108 which may optionally be running SIP softphone user agent applications, SIP servers 110, a base station network 112, a firewall 114 and router 116, a Public Switched Telephone Network (PSTN) gateway 118, and SIP telephones 120. While shown as separate and distinct devices, the various components of the enterprise system can be integrated in many ways, as is well known in the art. For example two or more of the server functions can be integrated into a single device, or can be integrated into the PBX 14.

The PBX 104 is connected to the SIP servers 110 over LAN 100, and communicates with the SIP servers using SIP. SIP servers are proxy servers that route requests to the user's current location, authenticate and authorize users for services, implement provider call-routing policies, and provide features to users. SIP also provides a registration function that allows users to upload their current locations for use by proxy servers. The PBX 104 is connected to telephones 106 via conventional circuit-switched connections. The PBX 104 is connected to the PSTN 122 via the PSTN gateway 118 as shown, or it can be directly connected using conventional PSTN lines and trunks (not shown). The SIP servers 110 are connected to the SIP telephones 120 and the PSTN gateway 118 via the LAN 100. The PSTN gateway 118 translates SIP call signaling and session messages into various PSTN corresponding protocols and signaling, as is well known.

Embodiments of the invention can be represented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the invention. Those of ordinary skill in the art will appreciate that other instructions data structures and operations necessary to implement the described invention can also be stored on the machine-readable medium. Software running from the machine-readable medium can interface with circuitry to configure a computer processor system to perform the described tasks.

The herein-described embodiments of the present invention are intended to be examples only. Those of skill in the art can effect alterations, modifications and variations to the particular embodiments without departing from the scope of the invention, which is defined solely by the claims appended hereto.

The LAN 100 is connected to a Wide Area Network (WAN) such as the Internet 128 and includes the ability to communicate and perform data messaging over cell network 132. In portions of the arrangement of FIG. 1, the voice network is implemented using traditional circuit switched nodes and also as Voice Over IP (VOIP) nodes that communicate utilizing established protocols over the enterprise and public data network portions of the arrangement of FIG. 1. The voice network spans both the enterprise domain and the public domain. Devices/boxes connected to the data network (including VOIP devices) typically include in memory of each device a unique network address such as an IP address. This allows data packets to be routed to the particular individual device (phone, server, gateway, base station, desktop, etc.)

Telephone handset devices, such as telephones 106 and 136 are connected to the circuit switched voice network and use traditional telephony signaling and addressing such as (telephone numbers or extension numbers. They are connected with standard interfaces such as twisted pair analogue loops, T1 trunks, or digital lines, to provide a few examples, in a manner well know to those skilled in the art. In summary, the LAN (100) interconnects: a Wireless Communication Gateway (124); PBX (104); SIP phones (120); workstations (108); SIP Servers (110); a Base Station Network (126); an Assisted Presence Server (102); a Firewall/Router (104/116); a PSTN Gateway (118) and the IP PBX (104). The IP PBX (104) uses SIP to communicate with the SIP Servers (110) and is connected to them via the LAN (100) and the IP PBX (104) is connected to Phones (106) via circuit-switched connections. The IP PBX (104) is connected to the PSTN (122) either via a PSTN Gateway (118) by direct connection (not shown). The SIP Servers (110) are connected to the PSTN Gateway (118) via the LAN (100). The PSTN Gateway (118) translates SI P into various PSTN protocols to enable inter operation between SIP and PSTN.

The SIP Phones (120) are connected to the SIP Servers (110) via the LAN (100). The Wireless Communication Gateway (124) communicates with the SIP Servers (110) using SIP via the LAN (100). The Wireless Communication Gateway (124) is connected to the Internet (128) through the LAN (100). The Assisted Presence Server (102) uses SIP (SIMPLE) to communicate with the Wireless Communication Gateway (124) and is connected via the LAN (100). There are wireless devices (130), which provide connectivity to the Cell Phone Network (132) via GSM/CDMA, and in the case of dual mode devices, to the Base Station Network (120) via WiFi (134). The Cell Network (132) connects to the PSTN (122) and the Internet (128). Any Voice calls will travel from the cell network to the PSTN via Trunks, and Data packets will travel from the cell network to the Internet.

An External Voice User phone (136) is connected to the PSTN (122) via Trunk (138). The Wireless Communication Gateway (124) can also monitor phones (106, 120) via the PBX (104) or SIP Servers (110) via a computer telephony integration (CTI) protocol.

The mobile devices, such as PDA (130) or WiFi phone (140), communicate with the Wireless Communication Gateway (124). It will be understood by those skilled in the art, that the various computer processor boxes 102, 104, 110, 114, 116 or 118 shown can be integrated in various embodiments in many different variations and combinations. For example, the PBX and SIP Servers could be in one box, the Wireless Communication Gateway could be in the same box as the SIP servers, or the SIP Servers and the PBX, and so forth.

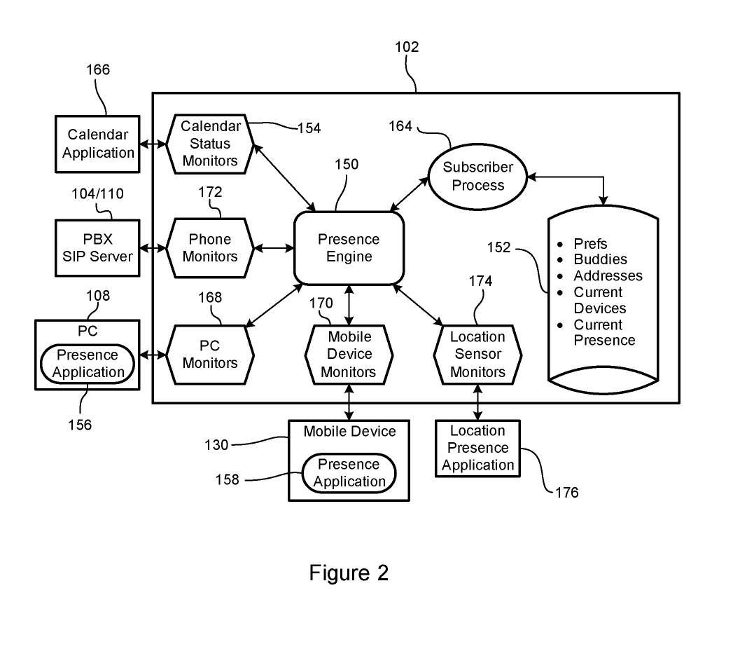

FIG. 2 is a functional process schematic diagram of an exemplary system software implementation according to an embodiment of the present invention for implementing assisted presence in accordance with principles of the invention. In the assisted presence server (102) there is a presence engine (150) that is responsible for maintaining subscribe presence indicator records in a presence data store 152, such as a processor local real time data store or a local or remote database. The presence data store records provide current presence information for enrolled subscribers and their associated data, including preference settings, buddies, addresses, current devices and current presence information. A user or subscriber enrolls by making a user presence monitor request using a input device, such as mobile device 130, PC 108 or telephones 106, 120.

A number of interface daemons are implemented to monitor user devices or applications to capture events and activities of a user and present them to the presence engine 150. For example, a calendar status monitor daemon (154) is provided for monitoring user calendar application 166 for user specified or configured triggers that are or may have an impact on that user's presence indicator. When the calendar status monitor presents an output to presence engine 150 that results in an update to the user presence record, the result is recorded in the presence data store 152. In this way, user presence information is made available to other user buddies when the user's presence changes. In the PC 108 and the Mobile Device 130 there is a presence application (156, 158) which is responsible for providing a user interface for setup of assisted presence preference settings, sending the assisted presence preference settings to the presence server (102) and for monitoring for triggers and sending them to the presence server. The presence application provides a user interface to prompt the user for input such as a presence change and for receiving buddy presence updates from the assisted presence server 102.

When a user enrolls or subscribes to the assisted presence server 102, for example through the PC or Mobile Device presence application (156, 158), then the presence engine (150) is informed through the corresponding application 156 or 158 running on the respective Mobile Device 130 or PC 108. The PC presence application 108 is monitored by a PC monitor daemon 168 and the mobile device presence application 158 is monitored by a PC monitor daemon 170. When a subscriber enrolls in assisted presence services, a new subscriber process 164 is created to track a unique user identifier for that user and maintain and update the corresponding presence record in the presence data store 152. Thus each enrolled subscriber is given a unique data store entry to store his or her respective information. The information that the presence applications (156, 158) send includes the user preference settings, which is where a user would configure, program or specify their ‘special’ settings. The user input includes selection and configuration of triggers the user is most interested in for setting of presence as well as providing the user with the ability to specify, what availability should apply in various circumstances. In the preferred arrangement the user availability indicator includes a colour aspect to indicate to others the user's availability. For example: Green (Go Ahead)—I am alone; Yellow (With caution)—I am with people, but can be disturbed, or Red (Emergency Only)—I am with people and cannot be disturbed or I have no media capability. (red, yellow, green). Moreover, the user is able to indicate and select a preferred media that should apply, such as voice, video, chat, email or fax for example. The user is able to input a message or note they want associated with the availability and what their preferred media is in particular situations.

As well as providing input to set these defaults, the user is able to configure the system to produce a prompt when a trigger occurs. The prompt provides a user with the option to provide further input when the prompt trigger occurs to enable the user to provide further input to accept, deny or reprogram the presence setting for that trigger when it occurs. When providing enrollment data, the user configures monitor parameters to specify the device identifiers for the devices and applications that are to be monitored. The device identifier specifies the particular device that is to be monitored and can take many forms depending on the device or context that the device has. A single physical device may have several device identifiers, each serving a particular purpose or context for communication, access or use. For example, a particular telephone handset of a PBX or SIP server 104/110 may use as a device identifier an extension number, a device physical address, such as a Media Access Control (MAC) address, or a logical address, such as an IPv4 or IPv6 address, or a public network address and port number, or a private network address to give a few examples of prospective device identifiers that may be used. Moreover a device might have multiple device identifiers, each specific to a particular type of communication methodology or context for use. For example, a PDA device may have a device identifier for use in cellular telephone communications that is the device telephone number, or the device Electronic Serial Number (ESN) or the device Mobile Equipment ID (MEID) to identify the device for voice communication in or over a wireless carrier network. That same PDA device, may also have a device identifier that is a Uniform Resource Identifier (URI), a MAC address, a Uniform Resource Locator (URL) or an IP address to permit communication with the PDA using a SIP agent, text messaging or email message for example. The main purpose of this identification is to enable interaction with representations of the device or resource over a network. The configured monitor parameters include accepting user input of address contact information, that is the user SIP URI, calendar information (e.g. Exchange™ address and/or login info), user buddies; any associated location sensors that are to be monitored (e.g. badge number) and/or any user specified associated devices (e.g. telephone extension number). The manner of communicating with and monitoring the device may be through a managing application such as with the PBX, SIP Server and Location presence application, 104, 110 or 176, or by installing a presence application 156, 158 to operate on the monitored device.

When a device or application is configured for monitoring, for example a calendar program and/or telephone device, the presence engine (102) then configures the corresponding monitor daemon 154, 168, 170, 172 and/or 174 to establish a monitor interface to the device corresponding to the device identifier, which results in a monitoring of the corresponding application, system or device. For example, when a user specifies a telephone number and/or SIP URI, the presence engine configures the phone monitor 172 to establish an interface to monitor the PBX 104 and/or SIP server 110 for the particular telephone handset or extension device for activity. The presence engine 150 sets and configures the phone monitor process 172, which then communicates with PBX or SIP server to establish or configure a monitor interface, for example, using a suitable CTI application interface like the Computer-Supported Telecommunications Applications (CSTA) protocol. Once configured, status changes (on-hook, off-hook, idle, busy) are reported to the presence engine.

When a user configures calendar information (e.g. exchange address), the presence engine then activates the calendar status monitor (154) to establish a monitor interface to monitor the user's calendar for status changes, which are then reported to the presence engine 150. Where the user configures location information, such as a badge that interoperates with an access system, the presence engine uses location sensor monitors 174 to interface with a location presence application 176 to maintain location status information for the users. Use of the location sensor, i.e. badge, is reported by the location presence application 176 to the location sensor monitor (174) to inform the presence engine (150) of any user location status changes.

When the presence engine (150) receives a status change for a particular subscriber from one of the monitoring processes, it passes it to the subscriber process (164). This process updates the subscriber location indicator record data in the subscriber presence data store 152. The subscriber data in the location indicator record of the subscriber presence data store 152 forms the basis for determining an action to take for the subscriber. The resulting action can be one or more of the following, namely: to take no action; to change the user's presence indicator automatically; to prompt or ask the user if they want to change their presence status. When the outcome is to change the presence automatically, then anyone that has this user in his or her buddy list is able to access this data from that users presence indicator record to become informed of the current status or the change of status for the user. If the outcome is to ask the user, then the presence engine is informed, which in turn uses the Mobile Device and PC Monitors (108, 130) to tell the Presence Applications (156, 158). These applications are then responsible for prompting the user for input indicting if the user wants his or her presence changed. If the answer is yes, then they inform the presence engine (through the monitors) of the change, which then informs anyone who has this user on their buddy list. Messaging for this purpose with a Mobile Device 130 can pass through the Wireless Communication Gateway (124).

The presence indicator includes indications such as a colour, a user note and/or a user specified preferred media that are presented to other eligible users. Other users that are able to access the subscriber presence indicator receive a user presence indication that is capable of different indications to such other subscribing users or buddies, where the differences depend on the group the other eligible user is in or the roles the other eligible user is subscribed to. Moreover, when a user subscribes or registers to the presence engine by providing a unique user id and a role or a group, multiple device identifiers corresponding to the specified user id and role or group may be included for monitoring by the presence engine. For instance, a user may have registered device identifiers for a desk phone and a PDA. When the user subscribes or registers with the presence engine from either the desk phone or the PDA, the presence engine may be configured by the user to monitor all of the devices that the user has requested monitoring for when any one of the devices for that user are used to subscribe or register the user again at a subsequent time. Moreover, when the user specifies a particular role or group that has predefined devices included for that role or group, the subscription or registration of a user to the particular role or group may result in monitoring by the presence engine of all devices in the particular role or group. For instance, the user may specify an employee badge number for a particular building or site, which will result in all badge sensors dispersed throughout that building or site being monitored by the presence engine to detect and report the presence or passage of the user badge device.

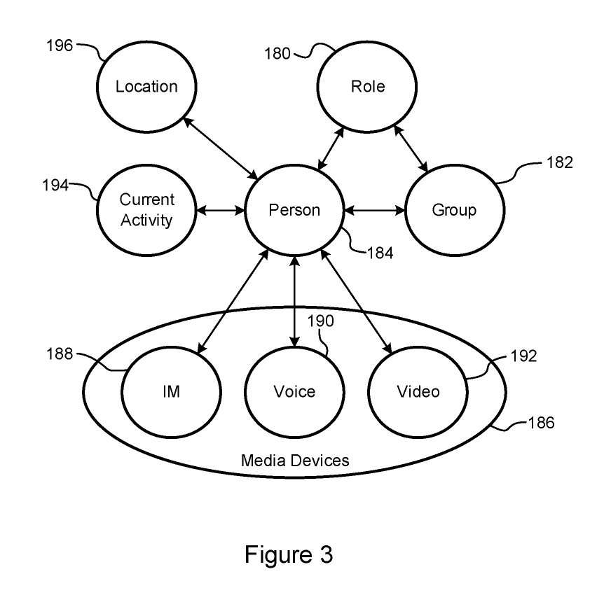

FIG. 3 shows a graphical representation of a framework for operation of a method and system for assisted presence with accordance with the principles of the invention. Subscribers or users of the system register with the system by providing characteristics that describe their use and operation of the system and relationship to other users of the system. A subscriber has a role 180, which defines functional characteristics of the user participating in the system. By way of example a user or subscriber may designate a role characteristic such as that of a doctor, a head nurse, or a role may be designated automatically by the system based on policy and a user that is a person filling a position such as that of a doctor or a head nurse. The user can carry out a certain function or functions in the role, such as for example, a doctor on-call or a head nurse making rounds in a hospital. Moreover, a user able to indicate membership in a group 182, such as for example, a group of doctors. A user indication of group membership is advantageously used to define common characteristics of users in that group. That is, group membership may be used to define users that share similar work functions or communication requirements. As an example, the group “doctors” includes the members “Smith”, “Brown” and “Kwon”. Thus, each person or subscriber 184 is permitted to provide an input that defines the role 180 and group 182 that that user is a member of. Each user has a media device 186 that is used to initiate and receive communications. Examples of the media devices include instant messenger applications 188, one or more voice devices 190 such as the telephones or wireless devices 106, 120 or 130, and may also include one or more video devices 192, through which the user can effect communications.

Once subscribed to the system, a user goes about their daily functions and carrying on current activities 194 at particular locations 196. Examples of current activities include doctors that are on-call or making rounds within a hospital or head nurses that are at located at a particular nurses' station or mobile within a hospital, such as making patient visits in a ward. The location and current activity information for a user is made available automatically through user interaction with one or more of the media devices or device interaction with a system element, such as a mobile communication device proximity to particular fixed devices, for example base station network 112, wireless communication gateway 124, cell phone network 132 or a user badge proximity to badge sensors. Therefore, when a user requests assisted presence functions, one or more aspects of a user presence are used to produce a user presence indication to others based on one or more or the user device or devices, the user role, the user group, the location of the user or the activity of the user. Similarly, others given access to a user presence indicator may receive an output of that user's user presence indicator based on the policy, role or group of the person given access. Consequently, a doctor may have a user presence indication provided to others in the doctor group to indicate the doctor is available to receive calls or messages but a user presence indication provided to others in another group or not in any recognized group, such as patients, that indicate the doctor is not available. Similarly a user is permitted to indicate which of the user's media devices are preferred where the preference is able to depend on the current activity of the user and/or the current location of the user.

The assisted presence system is particularly well suited to mobile users carrying a mobile communications device, for example a cell phone device, or a cell phone enabled PDA device that is capable of voice and data messaging communications or a cell phone enabled PDA device that has WiFi capability that is capable or voice and data messaging over the cell phone network and an network accessible from a WiFi capable wireless communications gateway. In such an application context, the assisted presence system is able to respond to movement of the user and/or interaction of the user with the device to produce triggers such as the mobile device active in the user's hand or stored in a pocket or device holster, or movement of the mobile device from WiFi to cellular mode, or a cellular mobile device going into cellular roaming or exiting into another cellular serving area that is accessible only through another cellular carrier.

When the user presence information is updated in the presence data store 152, the role and group membership of that person is used to determine which other users of the system that the user presence information will be made available to. Similarly, the presence data store provides the subscriber with the ability to input buddies for that subscriber which are other users of an instant message, voice or video device that has a shared application such as MSN Messenger or AOL Messenger by way of example. The user can access or communicate with the buddies on the user's buddy list using various media types. For example, where the user and the buddy each have corresponding access to one of voice, video, instant messaging (IM), facsimile or email media, then communication between the user and the buddy can take place using that media.

In this manner, a user is made aware of the presence information of other users or buddies of that user. In addition, the user is able to control publication of that users presence availability information to restrict access to the users presence indicator record in a manner selected by a user. For example, a user can restrict access to the publication of that users presence indicator record to members of a certain role 180 or group 182 or can change the availability indicator (red, yellow, or green) depending on the membership of the inquiring user in a particular role or group.

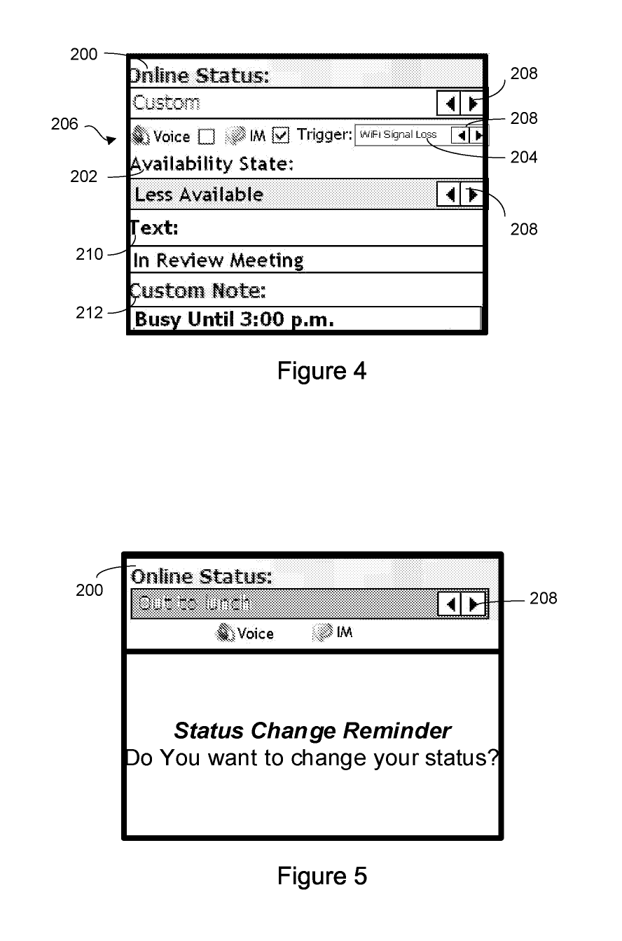

FIG. 4 illustrates a graphical user interface of an embodiment of the invention. The graphical user interface can be presented on a PC display or on a PDA display. Various input devices and methods to capture user input may be advantageously employed. For example, when the user operates the invention from a personal computer, personal computer input devices such as a keyboard and mouse can be used. Alternately, when the graphical user interface is presented on a PDA or mobile device, a typical mobile device input mechanism such as a touch screen, positioning sensor or a keyboard can be used. In this manner, the user is able to interact with the device using the graphical user interface as a means to provide outputs from the system to provide a framework for capturing input from a user. In the example embodiment of FIG. 4, an “Online Status” 200 is shown for the user, thus providing an output to the user of the current presence indication in the presence data store 152. A portion of the display allows the user to confirm and configure an “Availability State” 202 corresponding to a trigger event which is provided to the user. In the example FIG. 4, the trigger event is a “WiFi Signal Loss” event 204, which is but one example only of a trigger event. Trigger event portion of the display includes selection controls in the form of radio button boxes to select voice or instant message. In the example of FIG. 4, the instant message IM application is selected as indicated by the check mark in the radio button box next to the IM icon. Moreover, a control tool 208 can be manipulated by the user to input other selections. For example some other trigger condition than that of a WiFi signal loss condition. A control tool, which has “left” and “right” selection options, is illustrated as an example of a control 208. Similar control tools are shown for the “Availability State” selection options, which list a state of “Less Available” by way of example. The user is also able to input other availability indicator parameters such as “Text” 210 which lists “In Review Meeting” or a “Custom Note” 212 which is shown as “Busy Until 3:00 p.m.”

FIG. 5 illustrates graphical user interface of another embodiment of the invention. In the embodiment of FIG. 5, the user is prompted for an indication of whether or not to change their current presence indication status. The current presence indication status of the user of “Out to Lunch” and maybe changed to another status using the selection control tool 208.

While the invention has been described with reference to specific examples and embodiments that implement principles of the invention, the invention is not limited to such specific examples or embodiments but rather is defined by the claims appended hereto.

What is claimed is:

1. A method of managing a user presence indication, comprising:
receiving a user presence monitor request including a unique user identifier and a device identifier;
establishing a subscriber process having maintenance access to a subscriber presence record in a subscriber presence data store corresponding to said unique user identifier; and
establishing a monitor interface corresponding to said device identifier.

2. The method of claim 1, wherein said user monitor request includes a user group indicator.

3. The method of claim 1, wherein said monitor request includes a role indicator.

4. The method of claim 1, further including the step of storing device configuration information corresponding to said unique user identifier in said subscriber presence data store for at least one said device identifier.

5. The method of claim 2, further including the step of storing device configuration information corresponding to said unique user identifier in said subscriber presence data store for at least one device identifier corresponding to said group indicator.

6. The method of claim 3, further including the step of storing device configuration information corresponding to said unique user identifier in said subscriber presence data store for at least one device identifier corresponding to said role indicator.

7. The method of claim 4, further including the step of establishing a monitor interface to each device identifier configuration stored in said subscriber presence data store corresponding to said unique user identifier.

8. The method of claim 1, further including the steps of responding to a trigger from said monitor interface by performing at least one of updating a user presence indicator record in a presence data store for said unique user identifier or communicating over said monitor interface to cause a device corresponding to said device identifier to produce a user prompt.

9. The method of claim 1, wherein said monitor interface produces a trigger for a condition including: a mobile device active in a user's hand, a mobile device stored in a pocket or device holster; movement of a mobile device from WiFi to cellular mode; a cellular mobile device going into cellular roaming, a cellular mobile device exiting into another cellular serving area accessible through another cellular carrier.

10. The method of claim 1 wherein said subscriber process performs the steps of processing a user buddy list of said unique user identifier to produce an output of at least a portion of a presence indication record of each such buddy.

11. The method of claim 2 wherein said subscriber process performs the steps of processing a user buddy list of said unique user identifier to produce an output of at least a portion of a presence indication record of each such buddy of a matching group.

12. The method of claim 3 wherein said subscriber process performs the steps of processing a user buddy list of said unique user identifier to produce an output of at least a portion of a presence indication record of each such buddy of a matching role.

13. The method of claim 1, wherein the user presence indicator includes an indication for the unique user identifier of at least one of: a colour, a note or a preferred media.

14. The method of claim 13 wherein said colour includes green, yellow or red.

15. The method of claim 2, wherein said group indicator is an identifier of a pre-programmed group, a user selection, a previously determined group, a policy, or a user attribute.

16. The method of claim 2, wherein said group indicator is derived from a physical device or an application program.

17. The method of claim 3, wherein said role indicator is an identifier of a pre-programmed role, a user selection, a previously determined role, a policy, or a user attribute.

18. The method of claim 3, wherein said role indicator is derived from a physical device or an application program.

19. The method of claim 2, wherein said group indicator is a user attribute.

20. The method of claim 19, wherein the user attribute is derived from at least one of said user presence indicator, a proximity, a subscription to a device, or an indicator of availability.

21. The method of claim 8, wherein the trigger is an alarm, a condition set in a communicating application program, or a detection of a physical condition.

22. The method of claim 1, wherein the user presence indicator includes indication of at least one media type.

23. The method of claim 22 wherein said media type is voice, video, instant messaging (IM), facsimile or email.

24. An assisted presence server for managing user presence information, comprising:
a subscriber process coupled to a user presence data store to store and maintain a user presence indicator;
a communication device interface interoperable with said subscriber process to receive a unique user identifier and store same in said user presence data store; and
a device monitor interface in communication with said subscriber process to monitor each said communication device to process at least one of: a communication request, produce a user prompt, produce at least one trigger output or effect communication of at least one media type.

25. The server of claim 24, wherein the said at least one media type is voice, video, instant messaging (IM), facsimile or email.

26. The server of claim 24, wherein said communication device interface further includes means for producing an output of a user group indicator.

27. The server of claim 24, wherein said communication device interface further includes means for producing an output of a role indicator.

28. The server of claim 24, wherein said communication device interface further includes means for defining a user presence, and displaying user, group and role presence information.
